(19) United States
(12) Patent Application Publication
(10) Pub. No.: US 2006/0172770 A1
(43) Pub. Date: Aug. 3, 2006

(54) Presence management using wireless communication

(75) Inventors: Steven Fyke, Waterloo (CA); Roman Rak, (US)

Correspondence Address: ECKERT SEAMANS CHERIN & MELLOTT, 600 GRANT STREET, 44TH FLOOR, PITTSBURGH, PA, 15219, US

(73) Assignee: Research In Motion Limited

(21) Appl. No.: 11/047,386

(22) Filed: Jan. 31, 2005

(51) Int. Cl. H04M 1/00

(52) U.S. Cl. 455/557

(57) ABSTRACT

A presence management system enables an identification of a presence. i.e., a proximity, between a handheld electronic device having a wireless communication capability and another wireless communication device for the purpose of performing predetermined processing, and for other purposes. If a handheld electronic device is determined to be within a given proximity to a paired wireless communication device, the wireless communication device responsively interacts with an associated system in accordance with a predetermined profile that corresponds with the associated system and with the handheld electronic device. In another embodiment, a proximity can be determined between the handheld electronic device and a wireless communication device whereby the wireless communication device sends a request to the handheld electronic device. The handheld electronic device can then determine whether or not it desires to honor the request.

### BACKGROUND OF THE INVENTION

1. Field of the Invention

The invention relates generally to handheld electronic devices and, more particularly, to a method of managing the interaction of a handheld electronic device with an environment using wireless communication.

2. Background Information

Numerous types of handheld electronic devices are known. Examples of such handheld electronic devices include, for instance, personal data assistants (PDAs), handheld computers, two-way pagers, cellular telephones, and the like. Many handheld electronic devices also feature a wireless or other communication capability, although other handheld electronic devices are stand-alone devices that are functional without communication with other devices. Such handheld electronic devices are generally intended to be portable, and thus are of a relatively compact configuration. With advances in technology, handheld electronic devices are built to have progressively smaller form factors yet have progressively greater numbers of applications and features resident thereon.

Numerous types of wireless communication capabilities and formats can be implemented on a handheld electronic device. Wireless communication formats may include, for example, GPS, GPRS, Bluetooth, Wi-Fi, and the like without limitation.

With some wireless communication formats, such as Bluetooth, wireless communication devices regularly send out signals seeking to identify other wireless communication devices within a given range of transmission. With Bluetooth, the range of transmission typically is about ten meters. If two wireless communication devices identify one another, the wireless communication devices then must determine whether or not they have already been “paired”, meaning that each wireless communication device must determine if it has already been set to recognize the other wireless communication device as being “friendly”. If the two wireless communication devices have already been paired, then the two wireless communication devices can enter into a “handshake” mode, i.e., can begin communicating with one another. If the two wireless communication devices have not already been paired, the wireless communication devices do not further communicate with one another, although each wireless communication device may present to its user an opportunity to pair with the other device. It would be desirable to take advantage of the wireless communication capability of a handheld electronic device for purposes other than mere communication with other wireless communication devices.

### SUMMARY OF THE INVENTION

A presence management system enables an identification of a presence, i.e., a proximity, between a handheld electronic device having a wireless communication capability and another wireless communication device for the purpose of performing predetermined processing, and for other purposes. If a handheld electronic device is determined to be within a given proximity to a paired wireless communication device, the wireless communication device responsively interacts with an associated system in accordance with a predetermined profile that corresponds with the associated system and with the handheld electronic device. In another embodiment, a proximity can be determined between the handheld electronic device and a wireless communication device whereby the wireless communication device sends a request to the handheld electronic device. The handheld electronic device can then determine whether or not it desires to honor the request.

Accordingly, an aspect of the invention is to provide an improved method of providing functionality in response to an identified presence, i.e., proximity, between a handheld electronic device having a wireless communication capability and another wireless communication device.

Another aspect of the invention is to enable a system for which an operational profile has already been established to be caused to operate in accordance with the profile when a handheld electronic device having a wireless communication capability has been determined to be within a predetermined proximity to the system.

Another aspect of the invention is to enable a number of system functions to be automatically performed for a user of a handheld electronic device of a type having a wireless communication capability, with the functions being performed due to a presence of the handheld electronic device in various locations with respect to other wireless communication devices.

According, an aspect of the invention is to provide an improved method of interacting a handheld electronic device having a wireless communication capability and an environment that includes a number of client devices having a wireless communication capability. Each client device of at least a portion of the number of client devices is operatively connected with an associated system. The general nature of the method can be stated as including pairing the handheld electronic device with a plurality of client devices of the number of client devices, wirelessly detecting a predetermined proximity between the handheld electronic device and a client device of the plurality of client devices and, responsive to wirelessly detecting a predetermined proximity, interacting the client device and the associated system in a predetermined fashion.

Other aspects of the invention are provided by an improved method of interacting a handheld electronic device having a wireless communication capability and an environment that includes a number of client devices having a wireless communication capability. Each client device of at least a portion of the number of client devices is operatively connected with an associated system. The general nature of the method can be stated as including wirelessly detecting a predetermined proximity between the handheld electronic device and a client device of the plurality of client devices and, responsive to wirelessly detecting a predetermined proximity between the handheld electronic device and a client device, interacting the client device and the associated system in a predetermined fashion. The method further includes causing a communication directed to the handheld electronic device to be rerouted to an alternate device.

Other aspects of the invention are provided by an improved method of interacting a handheld electronic device having a wireless communication capability and an environment that includes a number of client devices having a wireless communication capability. The general nature of the method can be stated as including wirelessly detecting a predetermined proximity between the handheld electronic device and a client device of the plurality of client devices and, responsive to wirelessly detecting a predetermined proximity, wirelessly communicating to the handheld electronic device a request regarding a predetermined parameter of the handheld electronic device.

Other aspects of the invention are provided by an improved method of interacting a handheld electronic device having a wireless communication capability and an environment that includes a number of client devices having a wireless communication capability. The general nature of the method can be stated as including pairing the handheld electronic device with a client device of the number of client devices, the client device being operatively connected with an associated system, establishing a profile for the associated system with respect to the handheld electronic device, wirelessly detecting a predetermined proximity between the handheld electronic device and the client device and, responsive to wirelessly detecting a predetermined proximity, executing the profile.

### BRIEF DESCRIPTION OF THE DRAWINGS

A further understanding of the invention can be gained from the following Description of the Preferred Embodiment when read in conjunction with the accompanying drawings in which:

FIG. 1 is a schematic view of a number of devices that are interactable in accordance with a number of aspects of a method of the invention;

FIG. 2 is a exemplary flowchart depicting at least a portion of the method of the invention; and

FIG. 3 is another flowchart depicting at least a portion of the method of the invention.

Similar numerals refer to similar parts throughout the specification.

### DESCRIPTION OF THE PREFERRED EMBODIMENT

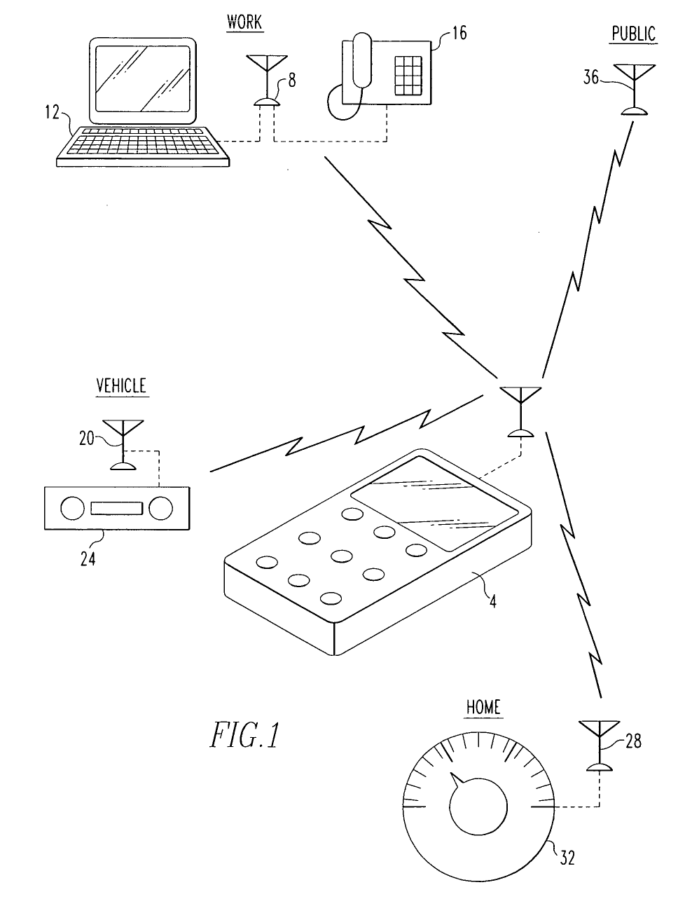

FIG. 1 generally depicts a handheld electronic device 4 in an environment with which it interacts. The handheld electronic device 4 has a wireless communication capability which, in the present example, includes Bluetooth wireless communication capability, although other and/or additional wireless communication capabilities may be employed on the handheld electronic device 4 without departing from the concept of the invention. As will be set forth in greater detail below, the presence, i.e., proximity, of the handheld electronic device 4 with other client devices having a wireless communication capability enables the client devices to interact with systems that are associated with the client devices to execute predetermined profiles for the systems, with the profiles relating to the handheld electronic device 4.

For example, the depicted environment includes a work environment where a work client device 8 having a wireless communication capability is disposed. All of the client devices mentioned herein include a wireless communication capability, even if not expressly mentioned elsewhere. The work client device 8 is operatively connected with, for example, a computer 12 and a telephone 16. The computer 12 and the telephone 16 can be referred to as systems that are operatively controlled by the work client device.

The work client device 8 in the present example has already been paired with the handheld electronic device 4. A profile may be stored for either or both of the computer 12 and the telephone 16. The profile(s) are executed whenever the handheld electronic device 4 is within a certain proximity with the work client device 8, i.e., within the range of radio communication, for example. Such a situation might occur, for instance, when the user who carries the handheld electronic device 4 arrives at his or her office. By way of further example, while Bluetooth communication typically has a range of about ten meters, the applicable range could be tunable on the wireless communication devices, and this can be the case with any wireless communication format.

A system profile may be stored, for example, in the system device itself, in the work client device 8, in the handheld electronic device 4, and/or in another location. When the handheld electronic device 4 is determined to be within the predetermined proximity to the work client device 8, the paired handheld electronic device 4 and the work client device 8 begin a handshake operation, i.e., the devices interact. The work client device 8 then executes either or both of the profiles related to the systems operatively connected therewith, i.e., the computer 12 and the telephone 16. By way of example, a profile for the telephone 16 might be to cause telephone calls which had been directed to the handheld electronic device 4 to be rerouted to the telephone 16. A profile for the computer 12 might be to cause electronic messages which had been directed to the handheld electronic device 4 to be rerouted to the computer 12. In this regard, it is understood that the profile may be executed on devices in addition to those generally depicted herein, i.e., servers may be updated to perform the rerouting of messages, and the like without limitation. It is also noted that the profile for any system can be as simple or as complicated as needed to operate the system.

In the present example, a user entering his or her office will automatically have telephone calls and electronic messages rerouted from the handheld electronic device 4 to other appropriate desktop hardware inside the office. Such a rerouting operation occurs essentially automatically upon a detection that the handheld electronic device 4 is within a predetermined proximity to the work client device 8, along with execution of profiles for the associated systems.

After such exemplary rerouting has been activated, the handheld electronic device 4 and/or the work client device 8 may identify an absence of the aforementioned proximity of the handheld electronic device 4 with the work client device 8, i.e., it might be determined that the user of the handheld electronic device 4 has left his or her office. Upon detecting an absence of such proximity, the work client device 8 may initiate other processing with respect to the systems associated therewith. For example, the telephone calls that had been rerouted to the telephone 16 and the electronic messages that had been rerouted to the computer 12 will now be directed back to the handheld electronic device 4. Other configurations will be apparent.

Another exemplary portion of the environment may include a vehicle environment that might include a vehicle client device 20 and, for example, a vehicle audio system 24. The vehicle client device 20 and the handheld electronic device 4 may have already been paired, and a profile already set up for the vehicle audio system 24. For example, the profile may be that when the handheld electronic device 4 is within a certain proximity of the vehicle client device 20, audible inputs into and audible outputs from the handheld electronic device 4, such as during a telephone conversation using the handheld electronic device 4, will be input and output via the vehicle audio system 24. Additionally or alternatively, the profile of the vehicle audio system 24 could, for example set a radio of the vehicle audio system 24 to a predetermined station and/or adjust the volume to a predetermined level.

Other systems that could be operatively connected with the vehicle client device 20 might include, for instance, the seats and the mirrors. If the seats and the mirrors are electrically movable, for example, they could serve as systems which, when the proximity of the handheld electronic device 4 is detected, could be adjusted to preset positions to suit the user of the handheld electronic device 4.

By way of further example, a home environment may include a home client device 28 and, for example, an operatively connected thermostat 32. The handheld electronic device 4 and the home client device 28 may have already been paired. When a proximity is determined between the handheld electronic device 4 and the home client device 28, a predetermined profile may be executed with respect to the exemplary thermostat 32. That is, the thermostat 32 may be adjusted to a predetermined temperature desired by the user of handheld electronic device 4. The home client device 28 could additionally or alternatively have lights, appliances, and/or other devices operatively connected therewith for operation in the same fashion upon detecting a proximity of the handheld electronic device 4.

Still another exemplary environmental region would be a public environment that might include a public client device 36. The public client device 36 may, for example, be inside a movie theater or inside a public library. It may be publicly desirable for all handheld electronic devices to be in a QUIET mode when in, for example, a movie theater and/or a public library. As such, upon a detection that the handheld electronic device 4 and the public client device 36 are within a given proximity, the public client device 36 may send a request to the handheld electronic device 4 that the device 4 be placed, for example, in a QUIET mode. In such a situation, the handheld electronic device 4 and the public client device 36 need not have previously been paired. However, it would likely be necessary for a profile on the handheld electronic device 4 to be set so that, upon receiving such a request from the public client device 36, the handheld electronic device 4 will determine whether or not the request can be honored. In such a situation, therefore, the public client device 36 can send out requests to the handheld electronic device 4 and/or any other handheld electronic device it identifies as being within a predetermined proximity. The profiles on the various handheld electronic devices can be set up to either honor such requests or to ignore such requests.

It thus can be seen that the method and concepts mentioned above enable many conveniences and other benefits to be afforded a user of the handheld electronic device 4. Such conveniences and benefits depend upon the presence of other wireless communication devices and systems operatively connected therewith, as well as preset profiles. The system can also provide benefits to the public as a whole by making desirable requests of handheld electronic devices at certain locations.

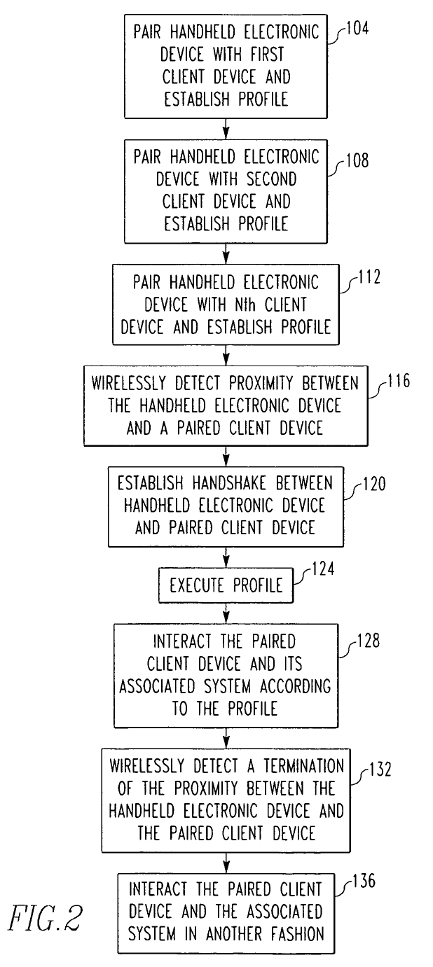

An exemplary flowchart of at least a portion of the method of the invention is depicted generally in FIG. 2. The general method would begin with pairing, as at 104, the handheld electronic device 4 with a first client device having a wireless communication capability and a system operatively connected therewith, and also establishing a profile for the associated system that will be executed upon detecting a proximity of the handheld electronic device 4 and the client device. A similar pairing, as at 108, can be made between the handheld electronic device 4 and a second client device, with corresponding establishment of another profile. Such pairing and establishment of profiles, as at 112, can be carried out for all of the client devices and associated systems desired.

After such pairing has been performed and profiles established, the handheld electronic device 4 and the various client devices can interact. For example, a proximity may be wirelessly detected, as at 116, between the handheld electronic device 4 and a paired client device. The handheld electronic device 4 and the proximate paired client device can then interact, as at 120, by establishing a handshake operation between handheld electronic device 4 and the paired client device. The paired client can then execute, as at 124, the profile for the system operatively connected therewith. In this regard, the profile may be unique to the particular handheld electronic device 4. That is, the paired client device may include numerous profiles for the same system, with the various profiles being executed in the proximity of different handheld electronic devices.

With execution of the profile, as at 124, the paired client device and its associated system can interact, as at 128, in accordance with the profile being executed. As such, the presence of the handheld electronic device 4 in proximity to the paired client device enables the system associated with the paired client device to operate in accordance with a desired predetermined profile, thus providing convenience and/or other benefits to the user of the handheld electronic device 4.

Upon wirelessly detecting, as at 132, a termination of the proximity between the handheld electronic device 4 and the paired client device, the paired client device and the associated system can interact, as at 136, in another fashion. For example, the system may be restored to its original state, turned off, set to a standby setting, or interacted with in any of a wide variety of fashions.

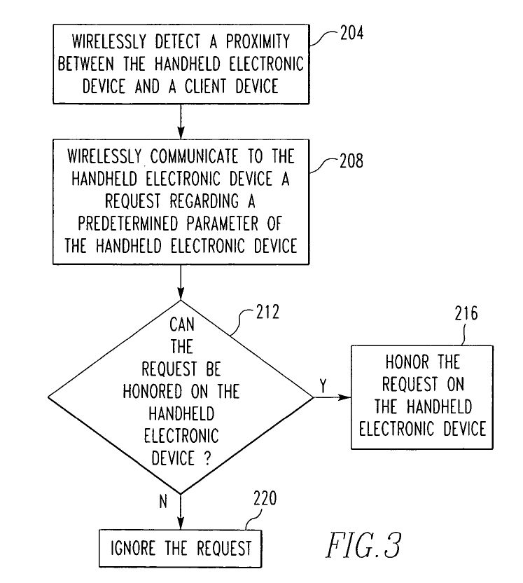

As is depicted generally in FIG. 3, and in accordance with another aspect of the method of the invention, a proximity may be wirelessly detected, as at 204, between the handheld electronic device 4 and a client device. The client device may then wirelessly communicate, as at 208, a request to the handheld electronic device 4 regarding a predetermined parameter of the handheld electronic device 4. For example, the client device may send a request that the handheld electronic device 4 be switched to a QUIET mode.

Upon receiving the request, the handheld electronic device 4 determines, as at 212, whether or not the request can be honored. If it is determined at 212 that the request can be honored, such as if a profile has already been set up on the handheld electronic device 4 to honor such requests, the handheld electronic device 4 can then honor, as at 216, the request. If it is determined at 212 that the request cannot be honored, the handheld electronic device 4 may then ignore the request as at 220.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A method of interacting a handheld electronic device having a wireless communication capability and an environment that includes a number of client devices having a wireless communication capability, each client device of at least a portion of the number of client devices being operatively connected with an associated system, the method comprising:
pairing the handheld electronic device with a plurality of client devices of the number of client devices;
wirelessly detecting a predetermined proximity between the handheld electronic device and a client device of the plurality of client devices; and
responsive to said wirelessly detecting a predetermined proximity, interacting the client device and the associated system in a predetermined fashion.

2. The method of claim 1, further comprising interacting the client device and the associated system in a predetermined fashion by interacting the client device and the associated system in accordance with at least a first predetermined parameter.

3. The method of claim 1, further comprising interacting the client device and the associated system in a predetermined fashion by causing a communication directed to the handheld electronic device to be rerouted to an alternate device.

4. The method of claim 1, further comprising wirelessly detecting an absence of the predetermined proximity between the handheld electronic device and the client device and, responsive to said wirelessly detecting an absence of the predetermined proximity, interacting the client device and the associated system in another predetermined fashion.

5. A method of interacting a handheld electronic device having a wireless communication capability and an environment that includes a number of client devices having a wireless communication capability, each client device of at least a portion of the number of client devices being operatively connected with an associated system, the method comprising:
wirelessly detecting a predetermined proximity between the handheld electronic device and a client device of the plurality of client devices;
responsive to said wirelessly detecting a predetermined proximity between the handheld electronic device and a client device, interacting the client device and the associated system in a predetermined fashion; and
causing a communication directed to the handheld electronic device to be rerouted to an alternate device.

6. The method of claim 5, further comprising wirelessly detecting an absence of the predetermined proximity between the handheld electronic device and the client device and, responsive to said wirelessly detecting an absence of the predetermined proximity, interacting the client device and the associated system in another predetermined fashion.

7. A method of interacting a handheld electronic device having a wireless communication capability and an environment that includes a number of client devices having a wireless communication capability, the method comprising:
wirelessly detecting a predetermined proximity between the handheld electronic device and a client device of the plurality of client devices; and
responsive to said wirelessly detecting a predetermined proximity, wirelessly communicating to the handheld electronic device a request regarding a predetermined parameter of the handheld electronic device.

8. The method of claim 7, further comprising honoring on the handheld the request.

9. The method of claim 8, further comprising determining from a profile on the handheld electronic device that the request can be honored.

10. The method of claim 8, further comprising honoring the request by ensuring that the predetermined parameter is set to a QUIET setting.

11. A method of interacting a handheld electronic device having a wireless communication capability and an environment that includes a number of client devices having a wireless communication capability, each client device of at least a portion of the number of client devices being operatively connected with an associated system, the method comprising:
pairing the handheld electronic device with a client device of the number of client devices, the client device being operatively connected with an associated system;
establishing a profile for the associated system with respect to the handheld electronic device;
wirelessly detecting a predetermined proximity between the handheld electronic device and the client device; and
responsive to said wirelessly detecting a predetermined proximity, executing the profile.

12. The method of claim 11, further comprising executing the profile by causing a communication directed to the handheld electronic device to be rerouted to an alternate device.

13. The method of claim 11, further comprising wirelessly detecting an absence of the predetermined proximity between the handheld electronic device and the client device and, responsive to said wirelessly detecting an absence of the predetermined proximity, interacting the client device and the associated system in a predetermined fashion.
